(19) United States
(12) Patent Application Publication
(10) Pub. No.: US 2004/0263471 A1
(43) Pub. Date: Dec. 30, 2004

(54) Remote controller capable of being received in a PCMCIA slot of a notebook computer

(76) Inventor: Bor-Wen Hsieh, Kuei Shan Hsiang (TW)

Correspondence Address: RABIN & Berdo, PC, 1101 14TH STREET, NW, SUITE 500, WASHINGTON, DC, 20005, US

(21) Appl. No.: 10/759,300

(22) Filed: Jan. 20, 2004

(30) Foreign Application Priority Data
Jan. 17, 2003 (TW) 92200894

(51) Int. Cl. G09G 5/00

(52) U.S. Cl. 345/156

(57) ABSTRACT

A card type of remote controller for controlling the screen of a notebook computer is disclosed. The remote controller substantially has a dimension of PCMCIA card and thus is capable of being received in a PCMCIA slot of the notebook computer.

### FIELD OF THE INVENTION

The present invention relates to a remote controller for controlling the screen of a notebook computer and, more specifically, to a remote controller which can serve as a laser pointer and is also capable of being received in the PCMCIA slot of a notebook computer.

### BACKGROUND OF THE INVENTION

In general, for those companies, academies or institutions, the projectors are widely applied to serve as display media in business meetings or science seminars for showing figures and other data. The prepared scripts and graphical material are photocopied onto the transparent films first. And then by means of placing these projection films on the flat pedestal of the projector, the related writing or figure data can be magnified and projected onto a hanging white board or a screen. However, it is real inconvenient for users because they have to prepare a stack of projection films and carry these films on one's person. Further, it is not satisfied the economical benefit, because when the contents require supplement, the users have to make the projection films again.

Recently, with the proceeding development and progress of computer technology, the prices of notebook computers rapidly descend and almost same as the prices of the desktop. And when the notebook computers are more widely applied and become the “standard equipment” in the enterprises, the projector capable of direct projecting the appearance of the LCD screen of the notebook computers becomes the main stream on the market. Especially by using the briefing software such as PowerPoint, users can amend the contents of the data files at any time and prettify the data by adding related designing patterns. Therefore, it can provide users more convenient and adequate editing space, and there is no need to prepare a large number of projection films.

When the above projection manner is introduced for briefing or meeting, the typical manner is to connect the projector, capable of transferring VGA signals, with the notebook computers so as to magnify and project the PowerPoint files onto the hanging white board or screen. Thus, the users can control the scrolling of the screen just via the keyboard of the notebook computer. However, for the most users, when they stand on the rostrum or beside the projection screen for explaining, it is very inconvenient to control the page up, page down or scroll keys of the notebook computers in the same time.

For solving this problem, in some designs, the notebook computer is fabricated with an extra remote controller, thereby the users can use the remote controller to control the scrolling of the appearance on the LCD screen. Generally, the remote controller is connected to the notebook computer with a cable line or by wireless transmission. And the user can use the remote controller to control the screen page up or down arbitrarily.

However, it is noted that for the most users, when they apply the projector for briefing or illustrating, they generally need to use a laser indicator for indication. By emitting the laser beam on the projecting image, the users can point out clearly what they want the audience to pay attention. But, it is yet inconvenient because the users have to hold the laser indicator and the remote controller simultaneously, for pointing somewhere in the projecting image and scrolling the screen simultaneously. Besides, when users carry the notebook computers to attend a meeting or seminar, they have to carry the laser indicator and the remote controller at the same time. So, it is still inconvenient for users.

### SUMMARY OF THE INVENTION

A card type of remote controller for controlling the screen of a notebook computer is disclosed in the present invention. The remote controller is capable of being received in a PCMCIA slot of the notebook computer. And in a preferred embodiment, the remote controller has a laser indicator for emitting a laser beam for indication.

Further, a notebook computer capable of scrolling the screen thereof by remote controlling is disclosed in the present invention. The notebook computer comprises of a card type of remote controller, capable of being received in a PCMCIA slot of the notebook computer, the remote controller can be taken out and applied to emit control signals for scrolling the screen of the notebook computer; and a signal receiver, fabricated on a motherboard of the notebook computer for receiving the control signals emitted from the remote controller to scroll the screen.

In a preferred embodiment, the remote controller comprises of: a circuit board is applied to receive the trigger signals detonated by pushing buttons fabricated on the remote controller for producing control signals; a transmitting module is electrically connected to the circuit board for sending the control signals to the notebook computer, so as to control the screen of the notebook computer; and a laser indicator is fabricated in a front part of the remote controller, for emitting laser beams for indication.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is illustrating the remote controller with a laser indicator in accordance with the present invention;

FIG. 2 illustrates the remote controller which is received in the PCMCIA slot of a notebook computer in accordance with the prior art; and

FIG. 3 illustrates the internal parts of the remote controller in accordance the first embodiment of the present invention.

### DETAILED DESCRIPTION OF THE PREFERRED EMBODIMENT

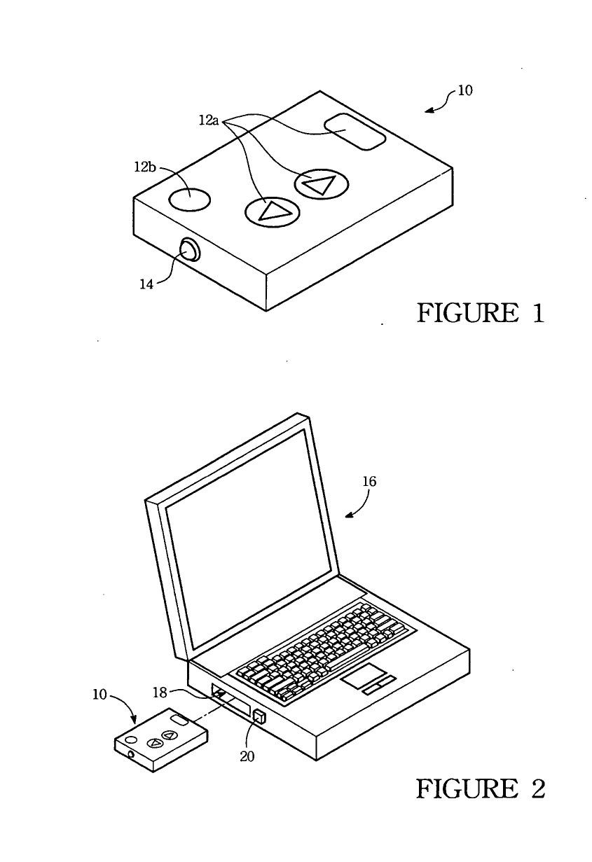

Please refer to FIG. 1, the card type of remote controller 10 for controlling the screen of a notebook computer is illustrated. As shown, on the upper surface of the remote controller 10 fabricated are several buttons 12, comprising first buttons 12a for controlling the screen of the notebook computer, such as “page up”, “page down”, and “eject” buttons and a second button 12b labeled as “emit” for switch on a laser indicator to emit a laser beam. When users press the “page up” and “page down” buttons 12a, the screen of the notebook computer can be remotely controlled to scroll. And when users press the “eject” button 12a, the notebook computer will close the file shown on the screen.

It is noted that on the front part of the card type of remote controller 10 further fabricated a laser indicator for providing the laser pointing function. As shown in the FIGURE, on the front terminal of the remote controller 10 has a slightly protruding laser head or diode 14. When users press the “emit” button 12a is pressed, the laser indicator is switched on and the laser head 14 on the front terminal of the remote controller 10 can emit a laser beam for indication.

Besides, it is noted that in the most notebook computers currently manufactured net chips are usually built in the motherboard thereof, so the PCMCIA slot fabricated on the side wall of the notebook computer is disused. Under such condition the card type of remote controller 10 provided in the present invention can be received in the PCMCIA slot, thereby promoting the space using rate and enhancing the convenience of portability of the remote controller 10. In a preferred embodiment, for containing the card type of remote controller 10 in the PCMCIA slot, the card type of remote controller is fabricated to substantially have a dimension of PCMCIA card, such as a length of 84.5˜85.0 mm, a width of 54.0˜55.0 mm and a height of 5.4˜5.5 mm.

Thus, as shown in FIG. 2, after users using the remote controller 10, it is easy to receive the remote controller 10 in the PCMCIA slot on the notebook computer 16. Further, besides the PCMCIA slot, the notebook computer 16 further has a handle 20 fabricated thereon. The handle 20 is designed originally for locking the PCMCIA card. So, when the remote controller 10 is inserted into the PCMCIA slot, the remote controller 10 also can be locked by pushing the handle 20, thereby preventing the remote controller 10 detaching from the notebook computer 16.

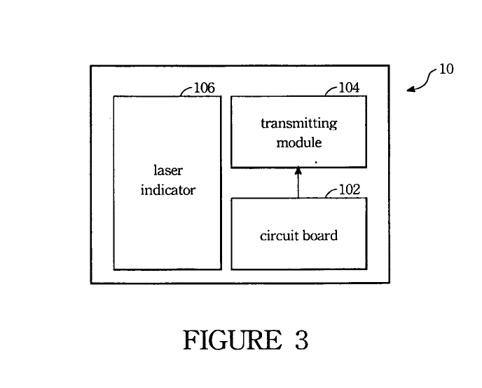

Please refer to FIG. 3, the internal block diagram of the remote controller 10 provided by the present invention is illustrated. The remote controller 10 comprises a circuit board 102, a transmitting module 104 and a laser indicator 106. The circuit board 102 is applied to receive the trigger signals detonated by pushing buttons 12a fabricated on the remote controller 10 for producing control signals. The transmitting module 104 is electrically connected and responsive to the circuit board 102 for sending those control signals to the notebook computer 16, so as to control the screen of the notebook computer 16. And the laser indicator 106 fabricated in the front part of the remote controller 10 can emit laser beams for indication when users press the “emit” button 12b.

Surely, for receiving efficiently the control signals from the remote controller 10, on the motherboard of the notebook computer 16, a receiver (not shown) is built in or inserted into the slot thereon. The receiver is also connected to keyboard controller of the notebook computer 16. Therefore, when the receiver receives the control signals emitted from the remote controller 10, the keyboard controller responsive to the control signals will control the screen of the notebook computer 16 to control the screen, such as page up, page down or eject.

The remote controller and the related receiving method provided in the present invention have a lot of advantages. First, because in the above embodiment the laser indicator is also integrated in the remote controller, it is very convenient for users to control the screen of the notebook computer and to operate the laser indicating function only holding single remote controller by one hand.

Second, because the remote controller can be received in the PCMCIA slot of a notebook computer, when users want to carry notebook computers outside to attend a meeting or seminar they do not need to carry the extra laser pen and the remote controller.

As is understood by a person skilled in the art, the foregoing preferred embodiment of the present invention is illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

While the preferred embodiment of the invention has been illustrated and described, it will be appreciated that various changes and modifications can be made therein without departing from the spirit and scope of the invention.

What is claimed is:

1. A card type of remote controller for controlling the screen of a notebook computer, wherein said remote controller is capable of being received in a PCMCIA slot of said notebook computer, said remote controller has a laser indicator for emitting a laser beam for indication.

2. The remote controller of claim 1, further having three command buttons of page up, page down, and eject fabricated thereon for scrolling the screen.

3. The remote controller of claim 1, further having a emit button fabricated thereon, when said emit button is pressed, said laser indicator is switched on and a laser head fabricated on a front side of said remote controller can emit a laser beam for indication.

4. The remote controller of claim 1, wherein said card type of remote controller has a length of 84.5˜85.0 mm, a width of 54.0˜55.0 mm and a height of 5.4˜5.5 mm.

5. The remote controller of claim 1, beside said PCMCIA slot of said notebook computer a handle is fabricated, when said remote controller is inserted into the PCMCIA slot, said remote controller can be locked by pushing said handle.

6. A card type of remote controller for controlling the screen of a notebook computer, capable of being received in a PCMCIA slot of said notebook computer, said remote controller comprising:
a circuit board, responsive to a trigger signals to produce a control signal; and
an transmitting module, electrically connected to said circuit board, for sending said control signal to said notebook computer, so as to control the screen of said notebook computer.

7. The remote controller of claim 6, wherein said card type of remote controller has a length of about 84.5˜85.0 mm, a width of about 54.0˜55.0 mm and a height of about 5.4˜5.5 mm.

8. The remote controller of claim 6, wherein said buttons comprise of page up, page down, and eject buttons for controlling the screen.

9. A notebook computer capable of controlling the screen thereof by remote control, said notebook computer comprising of:
a card type of remote controller, capable of being received in a PCMCIA slot of said notebook computer, said remote controller can emit a control signal for controlling the screen of said notebook computer; and
a signal receiver, fabricated in said notebook computer for receiving said control signals emitted from said remote controller to control the screen.

10. The notebook computer of claim 9, wherein said remote controller comprises of:
a circuit board, receiving a trigger signal for producing the control signal;
a transmitting module, electrically connected to said circuit board, for sending said control signal to said notebook computer, so as to control the screen of said notebook computer; and
a laser indicator, fabricated in a front part of said remote controller, for emitting laser beam for indication.

11. The notebook computer of claim 9, wherein said signal receiver is built in a motherboard of the notebook computer or inserted in a slot thereof.

12. The notebook computer of claim 9, further comprising a laser indicator, fabricated in a front part of said remote controller, for emitting laser beam for indication.

13. The notebook computer of claim 12, further having a emit button fabricated thereon and electrically coupled to said laser indicator, when said emit button is pressed, said laser indicator is switched on to emit the laser beam for indication.

14. The notebook computer of claim 9, wherein said card type of remote controller has a length of 84.5˜85.0 mm, a width of 54.0˜55.0 mm and a height of 5.4˜5.5 mm.

15. The notebook computer of claim 9, further having a handle fabricated beside said PCMCIA slot, when said remote controller is inserted into the PCMCIA slot, said remote controller can be locked by pushing said handle.
